(19) United States
(12) Patent Application Publication
(10) Pub. No.: US 2014/0365344 A1
(43) Pub. Date: Dec. 11, 2014

(54) RETAIL VIDEO MONITOR DISPLAY

(71) Applicant: Matthew J. Meyer, Versailles, OH (US)

(72) Inventor: Matthew J. Meyer, Versailles, OH (US)

(73) Assignee: Tagnetics, Inc., Troy, OH (US)

(21) Appl. No.: 14/300,689

(22) Filed: Jun. 10, 2014

Related U.S. Application Data
(63) Continuation-in-part of application No. 14/262,927, filed on Apr. 28, 2014.
Application No. 14/262,927 is a continuation-in-part of application No. 14/217,902, filed on Mar. 18, 2014.
(60) Provisional application No. 61/833,179, filed on Jun. 10, 2013.
(60) Provisional application No. 61/984,346, filed on Apr. 25, 2014.

(51) Int. Cl. G06Q 10/08; H04N 5/645; H04N 5/63

(52) U.S. Cl. CPC G06Q 10/087; H04N 5/63; H04N 5/645
USPC 705/28; 348/730; 348/840

(57) ABSTRACT

An apparatus, system, and method for operating video monitor displays in a retail environment. The apparatus comprises a base, cover, side, and divider which define a pair of compartments, each compartment configured to hold a video monitor display device such as a tablet, smart phone, or similar system. Each of the pair of compartments include apertures for viewing the screen of the video monitor display, and these apertures face opposition directions. The system generally comprises a video monitor display mounted to a retail shelf, a power supply for the video monitor display supplying power via an inductively coupled connection, a wireless Internet connection device integrated with the video monitor display, and associated hardware and software for downloading, storing, and displaying digital content on the video monitor display.

### CROSS-REFERENCE TO RELATED APPLICATION

This application is a Continuation-in-Part of U.S. patent application Ser. No. 14/262,927 filed Apr. 28, 2014, which is a Continuation-in-Part of U.S. patent application Ser. No. 14/217,902 filed Mar. 18, 2014. This application claims priority to U.S. Provisional Patent Application Ser. No. 61/833,179 filed Jun. 10, 2013 and U.S. Provisional Patent Application Ser. No. 61/984,346 filed Apr. 25, 2014. The entirety of these applications are incorporated herein by reference.

### FIELD OF THE INVENTION

The present disclosure generally relates to a video monitor display. More specifically, the present disclosure generally relates to an apparatus which displays video content on a display device which is mounted to retail store shelving.

### BACKGROUND

Many consumers make decisions about a specific product to purchase at the shelf of a retail store. In an effort to influence this decision process, retailers and packaged goods manufacturers use various advertising and promotional methods to highlight a specific product at the point of display. Retailers and packaged goods manufacturers are constantly searching for new and effective ways to promote their products while keeping advertising costs low.

One new trend in retail advertising is the use of video monitor displays at the retail shelf. These video monitor displays are used to show advertisements—either video or still frame—or informative videos about a product in an effort to influence purchase behavior. These displays generally receive electrical power via batteries or standard wall outlets. Batteries are problematic for use in this application because of their limited lifespan, limited power output, and the high personnel and material costs to replace them. Standard wall outlets allow for unlimited lifespan but require power conversion for most applications. Additionally, standard wall outlets are expensive to install, may be subject to national and local electrical codes, and carry additional safety concerns such as the need to be encased in conduit.

An additional problem with existing video monitor displays is the difficulty retailers have in updating the displays' content. Typically, a promotional video or advertisement is stored in a computer chip within the video monitor itself. When the content loaded on a computer chip becomes outdated, obsolete, or is simply no longer desired to show a customer, the content must be manually updated. This can be an expensive process involving high personnel costs; in fact, some retailers prefer to discard the entire video monitor rather than manually replace content. The problem is particularly acute for large retailers that use a large volume of video monitor displays in a single store—managing the content of each of these monitors is time-consuming and expensive.

Still a further problem with existing video monitor displays is that they are mounted flush to the retail shelving—which is to say parallel with the face of the shelving—and thus do not present an optimal cross-section for capturing a consumer's attention. These flush-mounted displays can also interfere with a consumer's ability to select products from the shelf or, if the display is large enough, require displacing products from the shelf altogether to accommodate the display. Such interference with consumers and under-utilized shelf space are undesirable to retailers. Yet another problem with the existing displays is that they are generally not re-usable.

One solution to the above problems that has been attempted is to place product displays at the ‘end cap,’ which is the end of an row of shelves. However, this solution is not ideal that the end cap space is generally considered the most valuable space in a retail store and it is undesirable to fill this space with video displays rather than products.

### SUMMARY OF THE DISCLOSURE

The present disclosure is directed to a video monitor display which obviates many of the deficiencies cited above. The present disclosure is generally directed to a system of displaying video content in a retail environment. The system comprises a display case, a video monitor disposed within the display case, and a power distribution system which is inductively coupled to the video monitor. The power distribution system may comprise a tag area controller, a primary distribution loop, and at least one inductively-coupled connection. In some embodiments, the system is integrated with an inventory control system and may display content based on signals received from the inventory control system.

The present disclosure further provides an apparatus for displaying video content in a retail environment. The apparatus comprises a base, cover, and side which collectively define a pair of compartments, each compartment configured to hold a video monitor display device such as a tablet, smart phone, or similar system. Each of the pair of compartments include apertures for viewing the screen of the video monitor display, and these apertures face opposition directions. This is to say a first aperture is provided in the base and a second aperture is provided in the cover. Electrical power is supplied to the displays via an inductively coupled connection. Video content is provided to the displays via the same inductively coupled connection or via a wireless connection to the Internet, an intranet, a host cloud, or similar system. The apparatus is configured to be mounted substantially normal to the face of a retail shelf.

The present disclosure further provides a method of updating locally-stored content at a video monitor comprising establishing a wireless connection between a content database and a video monitor, the video monitor mounted to a retail shelf and receiving electrical power from an inductively coupled connection to a power distribution system; searching for updated content; downloading updated content to a local memory of the video monitor; and displaying the updated content at the video monitor.

### BRIEF DESCRIPTION OF THE DRAWINGS

The foregoing and other advantages of the present disclosure will become apparent upon reading the following detailed description and upon reference to the drawings.

FIGS. 1A and 1B are isometric views of a mounting bracket for a video monitor display in accordance with some embodiments.

FIG. 2 is a schematic diagram of a power distribution system for a plurality of video monitor displays in accordance with some embodiments.

FIG. 3 is a schematic diagram of a content management system in accordance with some embodiments.

FIG. 4 is a schematic diagram of a content management system in accordance with some embodiments.

FIG. 5 is a schematic diagram of a content management system in accordance with some embodiments.

FIG. 6 is a block diagram of a process for updating content on a video monitor display in accordance with some embodiments.

FIG. 7 is a block diagram of a process for updating content on a video monitor display in accordance with some embodiments.

FIG. 8 is a block diagram of a process for updating content on a video monitor display in accordance with some embodiments.

FIG. 9 is an exploded isometric view of a display case in accordance with some embodiments.

FIG. 10 is a partially-exploded isometric view of a display case in accordance with some embodiments.

FIG. 11 is a partially-exploded isometric view of a display case in accordance with some embodiments.

FIG. 12 is an isometric view of an assembled display case in accordance with some embodiments.

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

The present disclosure is generally directed to a system and method of operating video monitor displays in a retail environment. Although the present disclosure is generally focused toward retail environments involving products stocked to shelves such as grocery stores and department stores, it would be apparent to one in the art that the present disclosure is applicable to a wider range of retail environments including restaurants and stores supplying services rather than goods. In short, the present disclosure may be used in any retail environment where retailers desire to operate video monitor displays to display content such as advertisements.

As used herein, the term ‘video monitor’ refers to an electronic device used to display video content such as a smartphone, tablet, television, or computer. A ‘video monitor display’ refers to the combination of a video monitor with a mounting bracket, display case, or similar apparatus.

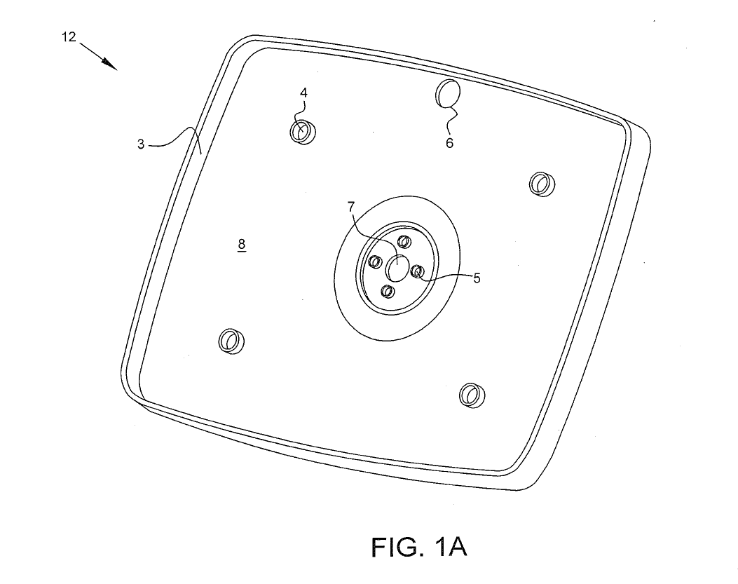

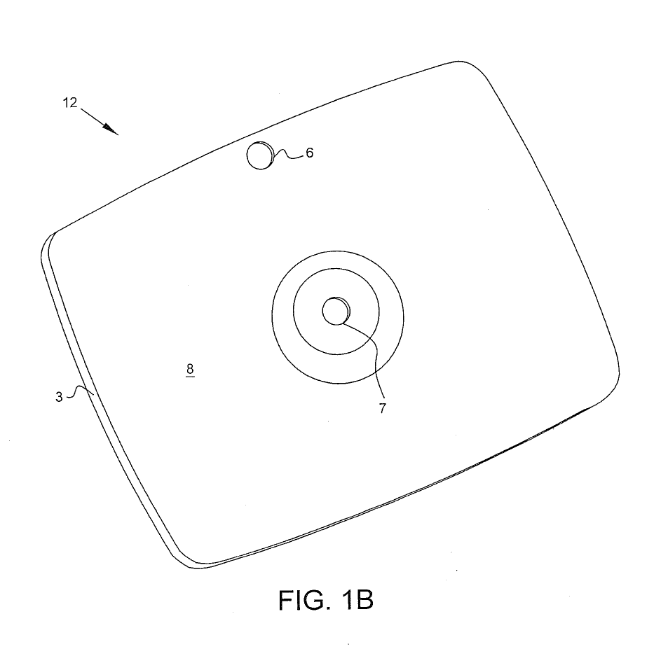

FIGS. 1A and 1B are isometric views of a mounting bracket for a video monitor display. FIG. 1A provides a front isometric view, while FIG. 1B provides a back isometric view of the same mounting bracket. The mounting bracket shown in FIGS. 1A and 1B is most appropriate for use in those embodiments where the video monitor display is a tablet computer.

As shown in FIG. 1A, mounting bracket 12 is configured to receive a video monitor 2. Mounting bracket 12 comprises a backing portion 8 and protective rim 3. Backing portion 8 defines a first access hole 6 and second access hole 7, which may be used to pass through wires, cables, power cords, and the like. First access hole 6 and second access hole 7 may further be used to attach a mounting device (not shown) which attaches mounting bracket 12 to a retail shelf. First mounting nodes 4, of a first size, and second mounting nodes 5, of a second size, are placed at intervals along backing portion 8 and used to attach a video monitor 2 to mounting bracket 12.

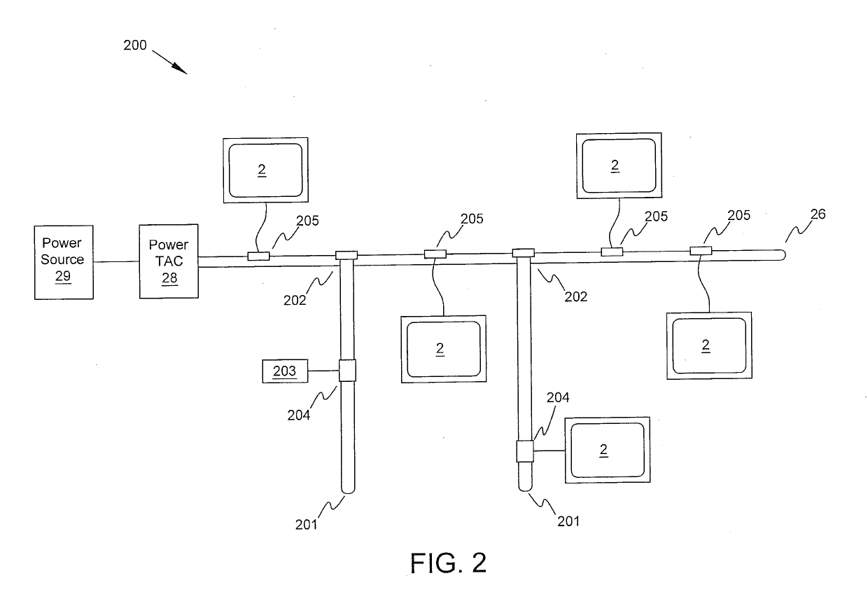

FIG. 2 is a schematic diagram of another embodiment of a video monitor power distribution system 200 for at least one video monitor 2 in accordance with some embodiments. In some embodiments, power distribution system 200 distributes power to a plurality of video monitors 2. In some embodiments, power distribution system 200 additionally distributes power to a plurality of electronic shelf labels (ESLs) 203.

In some embodiments power source 29 is a standard wall outlet well known in the art. Electrical power flows through a Power Tag Area Controller 28 to a power stringer 26. In some embodiments the power stringer 26 is called the primary distribution loop. In some embodiments power stringer 26 distributes power at between 45 and 50 VAC, 50 KHz, and 1 ampere. A frequency of 50 KHz was selected in part to comply with applicable regulatory requirements.

Power stringer 26 conveys power from the Power TAC 28 to at least one video monitor 2. Each video monitor 2 is connected to the power stringer 26 via a power converter 205. In some embodiments, power stringer 26 additionally conveys power to at least one secondary distribution loop 201. A secondary distribution loop 201 may also be referred to as a riser. Each secondary distribution loop 201 is connected to power stringer 26 via a primary-secondary connection 202. In some embodiments, the primary-secondary connection 202 is a step-down transformer which maintains the secondary distribution loop 201 at a lower voltage, frequency, and/or amperage than the power stringer 26. In other embodiments, the primary-secondary connection 202 maintains the secondary distribution loop 201 at the same voltage, frequency, and amperage as power stringer 26.

In the embodiments, such as that pictured in FIG. 2, a plurality of video monitors 2 are connected to a single power source 29 using a single power stringer 26 and a plurality of power converters 205. In some embodiments, a plurality of video monitors 2 may receive electrical power by a plurality of power sources 29 or a plurality of power stringers 26. In some embodiments, the power source 29 is connected to a power stinger 26 via inductive coupling. In some embodiments, at least one video monitor 2 is powered via the secondary distribution loop using a power coupler 204.

In some non-limiting embodiments, power converter 205 and power coupler 204 are those described in U.S. patent application Ser. No. 14/217,902.

In some embodiments, Power TAC 28 is a Tag Area Controller as used in a system of electronic shelf labels such as that disclosed in U.S. Pat. Nos. 5,537,126; 5,736,967; 6,249,263; 6,271,807; and 6,844,821. In other embodiments, Power TAC 28 may be removed from power distribution system 200 allowing each power converter 205 to connect to the power source 29. In some embodiments, the Power TAC 28 is an electrical power strip. From power converter 205 power is provided to a promotional glass holder 2 In some embodiments, the control for a Power TAC 28 is provided by a general purpose computer processor. In some embodiments, the electronic shelf labels 203 are connected to the secondary distribution loop via a power coupler 204.

In some embodiments, a plurality of video monitors 2 receive electrical power from a plurality of power sources 29 or a plurality of low voltage power stringers 26.

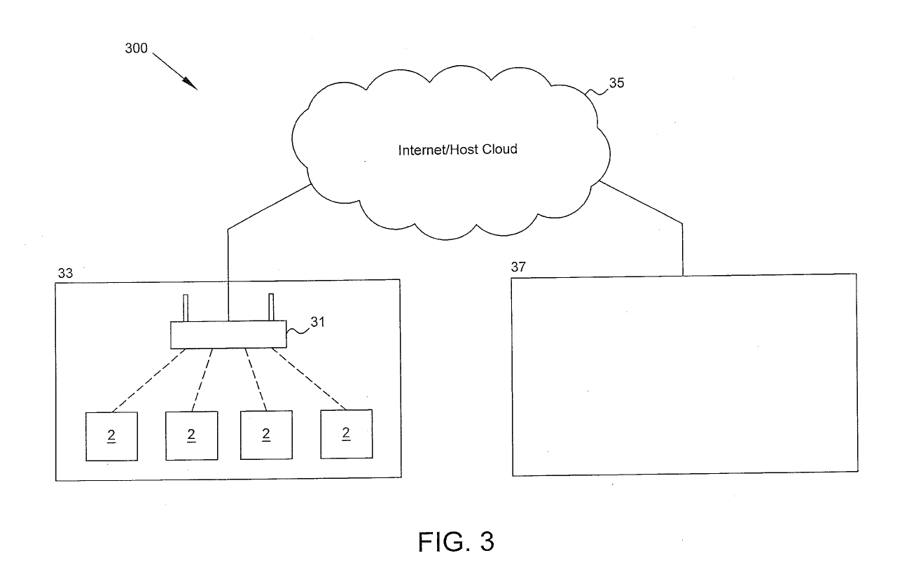

FIG. 3 is a schematic diagram of a content management system 300 in accordance with some embodiments. A content management system 300 remotely controls the content being shown on a plurality of video monitors 2. Each video monitor 2 connects wirelessly to an access point 31 in a retail store 33. Access point 31 is connected to a host cloud 35, which is an Internet-based content database storing content to be displayed on video monitors 2. Host cloud 35 is connected via the Internet to a host cloud controller 37, which may be a retailer or a third party service provider. Host cloud controller 37 operates and maintains host cloud 35.

In operation, host cloud controller 37 loads content into the host cloud 35. Each video monitor 2 connects, via access point 31, to the host cloud 35 to update its content. This update may be performed at regular intervals (i.e.—daily or weekly) or may be prompted by the host cloud 35. Host cloud controller 37 may also remove content from host cloud 35.

Content is downloaded onto a local memory device, which is a non-transitory computer readable medium, in the video monitor 2. Content may be downloaded as a single video, a single image, or as a more complex content ‘package.’ If a single video is downloaded, the video monitor display shows the video on a continuous loop or runs the video once at each of a predetermined interval. For example, a 30-second video may be shown once every two minutes, leaving 90 seconds for the video monitor 2 to power off. Similarly, if a single image is downloaded, the image is shown continuously or shows for a predetermined period at a predetermined interval.

A video monitor 2 may also download a content package with more complex instructions for display. In some embodiments, a content package includes a series of advertisements, images, and informative videos which would be displayed in succession. For example, a content package may include a first video, which is an advertisement for a product placed near the video monitor 2, a second video, which is an informative piece that explains the product's benefits and uses to a consumer, and a series of images which show the product in use. First video, second video, and the series of images may be played in succession on a continuous loop, or may be played in succession once at each of a predetermined interval.

Video monitors 2 can also be programmed to power on just before the retail store opens for customers during the day and to power off after the store has closed in the evening. This feature significantly reduces power consumption by the video monitors 2.

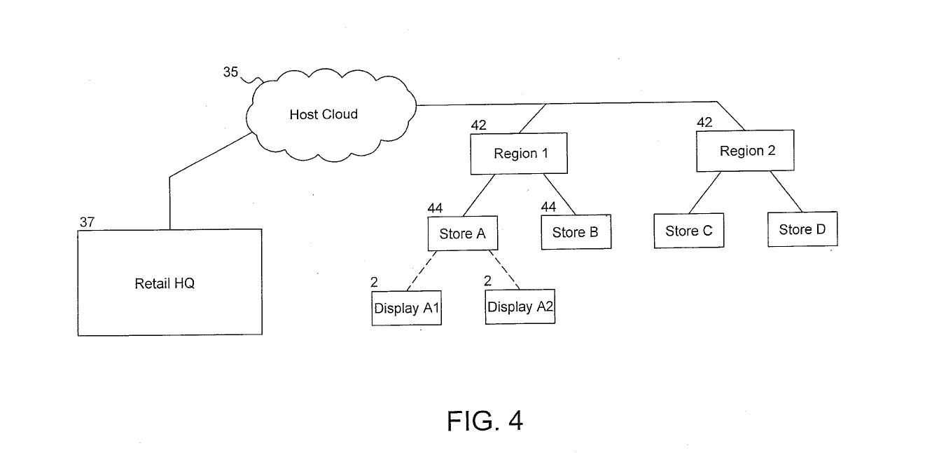

FIG. 4 is a schematic diagram of a content management system in accordance with some embodiments. In FIG. 4, a host cloud controller 37 is connected to host cloud 35, which is an Internet-based content database storing content to be displayed on video monitors 2. Host cloud 35 distributes content according to geographical regions 42 and the retail stores 44 within each region 42. This configuration enables a large retailer to disseminate content throughout its retail stores.

Within a single retail store 44, a plurality of video monitors 2 may be sequentially designated or assigned unique identifiers or addresses. In FIG. 4, this is illustrated with a first video monitor display “A1” and a second video monitor display “A2,” both located in retail store “A.” Providing each video monitor 2 with a unique address allows a retailer 37 to control the content to each video monitor 2 in each retail store 44.

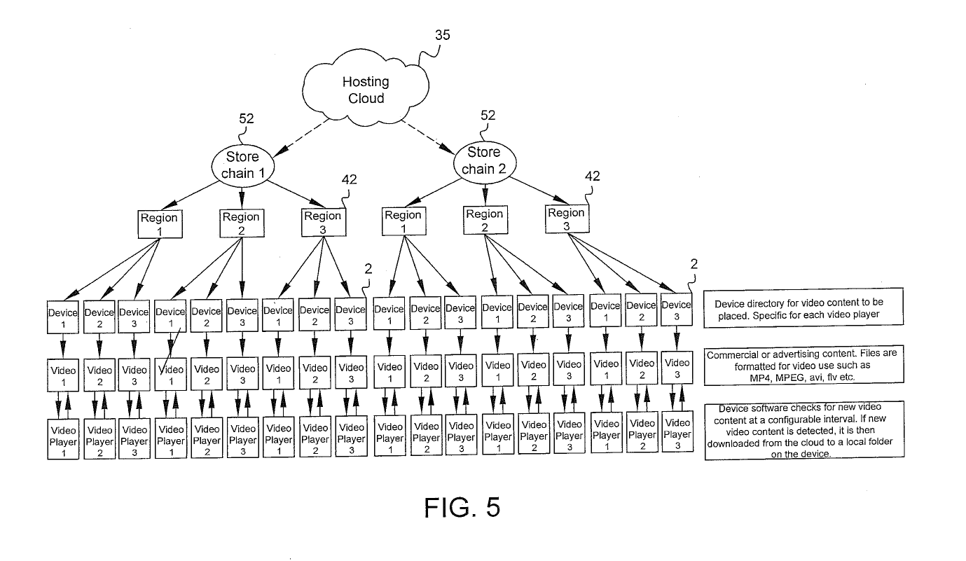

FIG. 5 is a schematic diagram of yet another embodiment of a content management system, showing that host cloud 35 may be used by more than one retailer 52 to distribute content to according to region 42. The content is distributed to individual video monitors 2 according to the region 42 that each video monitor 2 is in.

Video monitors 2 may be further categorized within a region 42 to assist in the distribution and management of content. For example, each retail store in a region 42 may include a single video monitor 2 designated for a certain brand of soup. In each retail store, a video monitor 2 is mounted to a retail shelf containing this brand of soup. The video monitor 2 displays advertisements, videos, and images associated with this brand of soup in an effort to influence consumer's purchase behavior. When a retailer wishes to update the content displayed by this video monitor 2, it uploads new or modified content to the host cloud 35, specifically to the category of video monitors 2 associated with the certain brand of soup. Each of the video monitors 2 in that category then downloads the new or modified content from the host cloud 35 and begins to display the new or modified content. Thus, the retailer has updated a plurality of video monitors 2 at a plurality of retail stores 44 with the requirement for individually updating each video monitor 2.

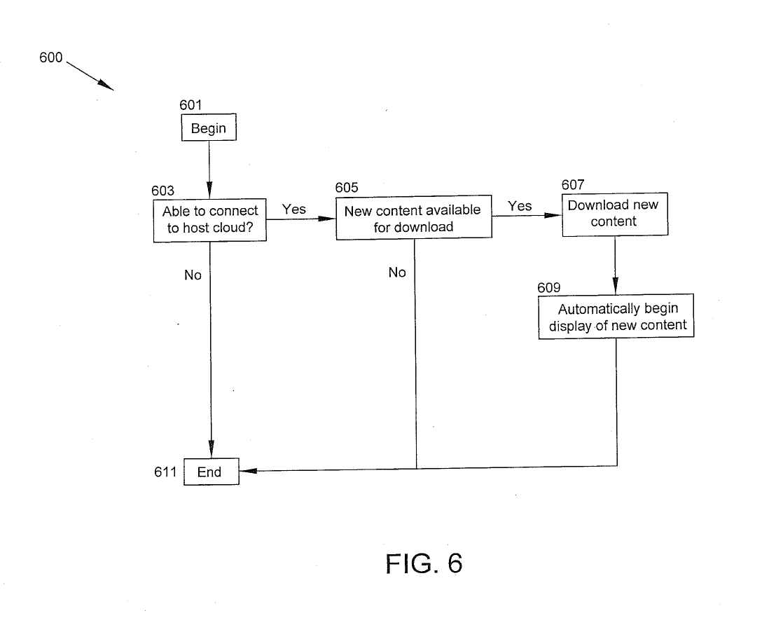

FIG. 6 is a block diagram illustrating a process for updating content on a video monitor 2. The process begins at block 601, and at block 603 the video monitor 2 attempts to connect to the host cloud via the Internet. If this attempt fails, the process ends at block 611. If the video monitor 2 is able to connect to the host cloud, the process moves to block 605 where the video monitor 2 searches for new content. If no new content is found, the process ends at block 611. If the video monitor 2 finds new content available for download, it will download the content at block 607 and, once downloaded, may automatically begin displaying the content at block 609. Once the video monitor 2 automatically begins displaying the content, the process ends at block 611. Once the process ends, the video monitor 2 will be displaying whichever content was the most recently downloaded. After a predetermined interval, the process will begin again at block 601.

In some embodiments, a video monitor 2 is updated with modified content rather than new content. Searching for modified content in the host cloud rather than new content allows host cloud controller to update existing content. For example, if a video monitor 2 plays three videos in a sequence—Video A, Video B, and then Video C. A host cloud controller may desire to alter the sequence such that the videos are played as Video A, Video C, and then Video B. Similarly, host cloud controller may desire to remove one of the videos from the sequence. Video monitor 2, searching the host cloud for modified content, would know to update the content in the local memory device of video monitor 2 based on the detection of modified content even though no new content was added to the host cloud.

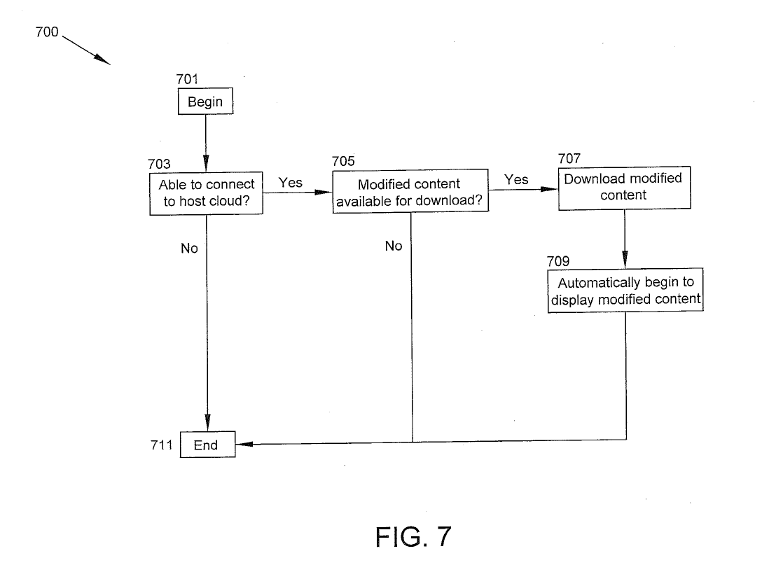

This process is illustrated in the block diagram of FIG. 7. The process begins at block 701, and at block 703 the video monitor 2 attempts to connect to the host cloud via the Internet. If this attempt fails, the process ends at block 711. If the video monitor 2 is able to connect to the host cloud, the process moves to block 705 where the video monitor 2 searches for modified content. If no modified content is found, the process ends at block 711. If the video monitor 2 finds modified content available for download, it will download the content at block 707 and, once downloaded, may automatically begin displaying the content at block 709. Once the video monitor 2 automatically begins displaying the content, the process ends at block 711. Once the process ends, the video monitor 2 will be displaying whichever content was the most recently downloaded. After a predetermined interval, the process will begin again at block 701.

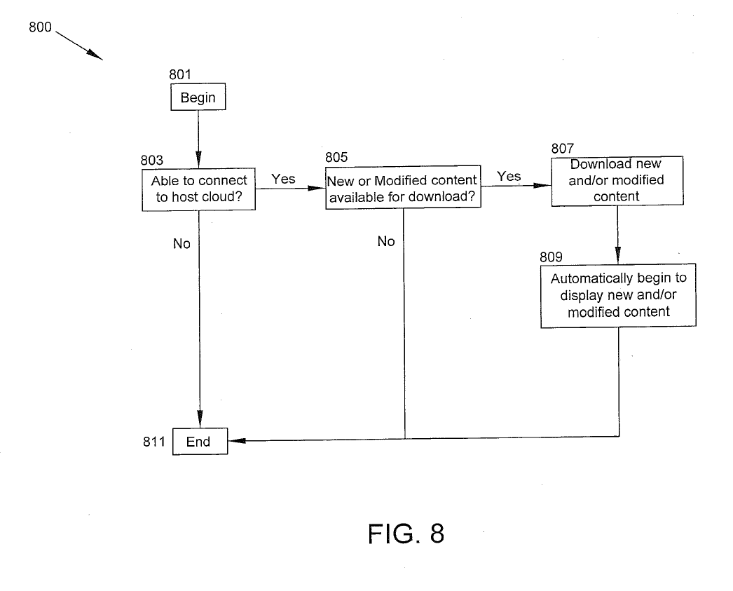

In some embodiments, video monitor 2 is configured to check the host cloud for both new and modified content, and to download either new or modified content, or both, if either is discovered. This process is illustrated in the block diagram of FIG. 8. The process begins at block 801, and at block 803 the video monitor 2 attempts to connect to the host cloud via the Internet. If this attempt fails, the process ends at block 811. If the video monitor 2 is able to connect to the host cloud, the process moves to block 805 where the video monitor 2 searches for new or modified content. If no new or modified content is found, the process ends at block 811. If the video monitor 2 finds new or modified content available for download, it will download the content at block 807 and, once downloaded, may automatically begin displaying the content at block 809. Once the video monitor 2 automatically begins displaying the content, the process ends at block 811. Once the process ends, the video monitor 2 will be displaying whichever content was the most recently downloaded. After a predetermined interval, the process will begin again at block 801.

The process described above and illustrated in FIGS. 6, 7, and 8 is advantageous for large retailers because it eliminates the need to manually re-program and update content on video monitors 2. Especially for large retail stores with numerous video monitors 2, this process that uses (1) automatic polling at a predetermined interval for new or modified content, (2) automatic downloading of available new or modified content, and (3) automatic display of newly-downloaded content can greatly reduce personnel expenses involved in manual updates.

It is important to note that the processes of FIGS. 6, 7, and 8 may utilize the system embodiments illustrated in FIGS. 3-5. A video monitor 2, upon connecting to the host cloud, may only search for new or modified content for its assigned region or store. This allows a retailer or host cloud controller to separate content by region, store, and individual video monitor 2.

In still further embodiments, a video monitor 2 includes circuitry for communicating via a low-voltage power supply such as that disclosed in U.S. Pat. Nos. 5,537,126; 5,736,967; 6,249,263; 6,271,807; and 6,844,821. These patents disclose a system for providing electrical power and communications to a plurality of electronic shelf labels 203 via inductive coupling. The area controller disclosed in these patents may be further used to send communications to a plurality of video monitors 2. In this embodiment, video monitors 2, rather than downloading content individually, could receive content from the area controller, which may downloaded all content for a retail store and distribute it via the power and communication network to each of the video monitors 2.

In still further embodiments, a system of displaying advertisements using a video monitor 2 mounted at a retail shelf includes a motion sensor. The motion sensor is operationally connected to video monitor 2 and configured to detect motion at a predetermined distance from the video monitor 2. In this embodiment, the video monitor 2 is configured to power off or ‘sleep’ or ‘hibernate’ once content display has completed. When motion is detected by the motion sensor, the video monitor 2 is configured to power on or ‘awake’ and display a content. If displaying an image, the video monitor 2 may display the image for a predetermined time. If displaying a video, the video monitor 2 may display the video a predetermined number of times. After displaying content, the video monitor 2 returns to power off, ‘sleep,’ or ‘hibernate.’ This mode would likely save significant power consumption as the video monitor 2 would only power on as necessary.

In another embodiment, the video monitor 2 may be integrated with an inventory control system such as disclosed in pending U.S. patent application Ser. Nos. 14/152,644 and 14/152,678. For example, when a customer removes a can of soup from a shelf, the inventory control system may detect the removal of the can of soap from the shelf The inventory control system may provide a signal to the video monitor in close proximity to the soup shelf to start a video that may advertise a product related to soup such as crackers. Thus, the video monitor 2 may provide targeted advertisements based on inputs from the inventory control system.

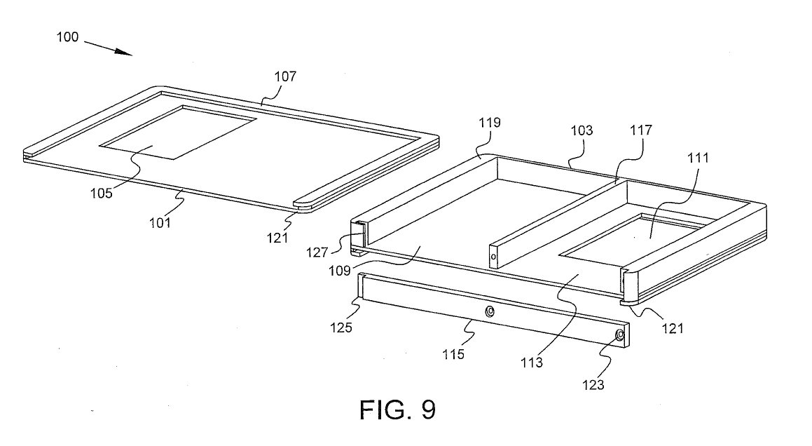

FIG. 9 is an exploded isometric view of a display case 100 in accordance with some embodiments. Display case 100 is configured to receive at least one video monitor 2. Display case 100 comprises a base 103, cover 101, and side 115. Base 103 includes a first compartment 109 and second compartment 113, which are separated by divider 117. First compartment 109 and second compartment 113 are configured to each hold a video monitor display device such as a tablet, smart phone, or similar device. In some embodiments, divider 117 may include various holes to allow wires to be connected between first compartment 109 and second compartment 113.

Base 103 also defines a lower aperture 111. An exterior frame 119 surrounds three sides of the first and second compartments 109, 113. In some embodiments, exterior frame 119 includes a retaining ridge 121 configured to hold in place advertisements or graphics printed on card stock, paper, laminate, or similar material. Such advertisements are slid into place and held by retaining ridge 121.

In some embodiments, base 103 is formed as a unitary component, such as by injection molding. In some embodiments, base 103 is manufactured in various constituent pieces and assembled to form base 103. In some embodiments, base 103 is formed from plastic or similar material.

Cover 101 defines an upper aperture 105. An exterior ridge 107 surrounds the edge of cover 101. In some embodiments, exterior ridge 107 includes a retaining ridge 121 configured to hold in place advertisements or graphics printed on card stock, paper, laminate, or similar material. Such advertisements are slid into place and held by retaining ridge 121. Cover 101 is configured to be disposed above and attached to base 103. In some embodiments, cover 101 is attached to base 103 using a screw or similar attachment mechanism. In some embodiments, cover 101 is attached to base 103 using an adhesive.

In some embodiments, side 115 includes at least one hole 123 for passing through a screw to connect side 115 to base 103. The at least one hole 123 may have corresponding screw holes on the exterior frame 119 or divider 117. In some embodiments, side 115 includes an extrusion 125 configured to be disposed within a slot 127 in the exterior frame 119 to hold side 115 to base 103.

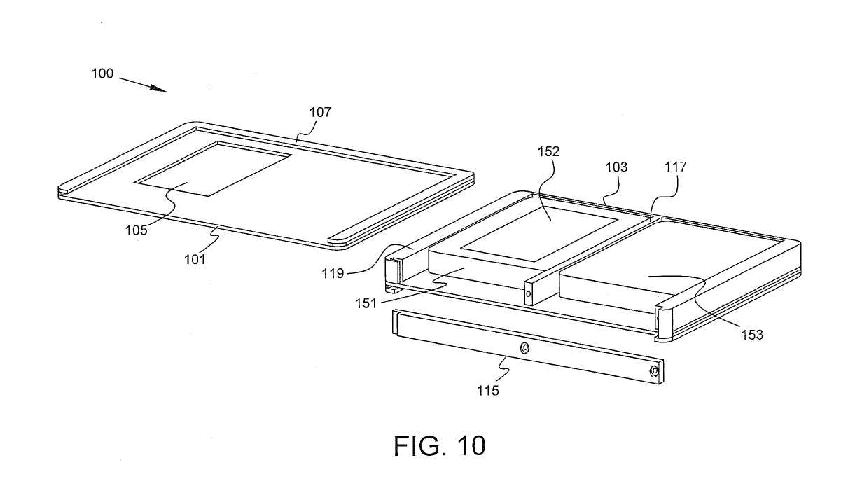

FIG. 10 is a partially-exploded isometric view of a display case 100 in accordance with some embodiments. In FIG. 10, a first video monitor 201 is disposed in first compartment 109 and a second video monitor 153 is disposed in second compartment 113. The screen 152 of first video monitor 151 faces upper aperture 105, which the screen of second video monitor 153 (not shown) faces lower aperture 111. With first video monitor 151 and second video monitor 153 disposed within the base 103, the display 100 is ready for assembly.

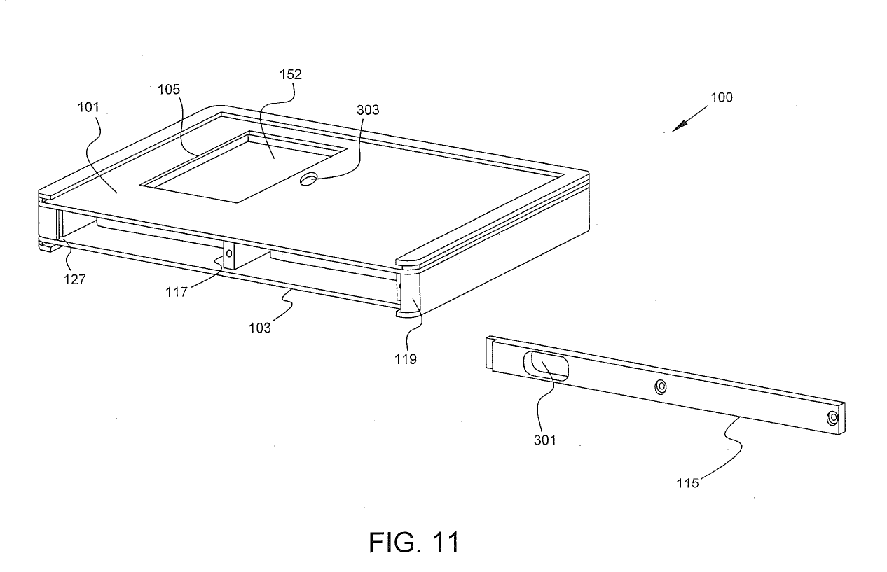

FIG. 11 is a partially-exploded isometric view of a display case 100 in accordance with some embodiments. In FIG. 11, cover 101 is connected to base 103. Upper aperture 105 is aligned with the screen 152 of first video monitor 151. In some embodiments a hole 303 is provided for passing through a screw to attach cover 101 to base 103. In some embodiments, hole 303 aligns with a screw hole (not shown) on divider 117.

In some embodiments, such as that illustrated in FIG. 11, side 115 may define a side aperture 301 which is used to connect cables and/or wires from first video monitor 151 and second video monitor 153 to a power supply or communications link which is external to display case 100. In some embodiments, such cables and/or wires form an inductively coupled connection with a power and/or communication supply.

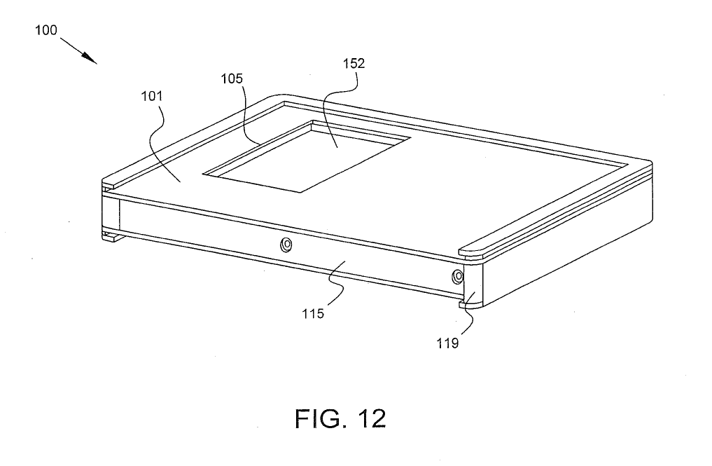

FIG. 12 is an isometric view of a display case 100 in accordance with some embodiments. In FIG. 12, first video monitor 151 and second video monitor 153 are disposed within display case 100 to form a video monitor display. Extrusion 125 is disposed within slot 127, and screws are used to attached side 115 to base 103. Thus cover 101, base 103, and side 115 are attached to form display 100. Display case 100 includes a first video monitor 151 and second video monitor 153. The screen 152 of first video monitor 151 is aligned with upper aperture 105, while the screen (not shown) of second video monitor 153 is aligned with lower aperture 111.

In some embodiments, display case 100 is mounted substantially normal to a retail shelf. In other words, the face of a retail shelf defines a first plane and display case 100 is mounted substantially normal to the first plane. Mounting substantially normal to the retail shelf ensures an adequate viewing angle such that consumers in an aisle between retail shelves or walking along a retail shelf will be able to view the display.

Display case 100 is mounted to the shelf using a wire hanger, a mounting bracket, or similar device. In some embodiments, a mounting bracket is configured to provide under-mounting, where the bracket is connected to the underside of a retail shelf.

In still further embodiments, display case 100 includes apertures—either in the cover, the base, or both—to accommodate the sensor portion of a motion sensor. The motion sensor is configured to detect motion at a predetermined distance from the display case 100, and to trigger the video monitors 201, 203 to display video content when motion is detected. In this embodiment, the video monitors 201, 203 are configured to power off or ‘sleep’ or ‘hibernate’ once content display has completed. When motion is detected by the motion sensor, the video monitors 201, 203 are configured to power on or ‘awake’ and display a content. If displaying an image, the video monitor may display the image for a predetermined time. If displaying a video, the video monitors 201, 203 may display the video a predetermined number of times. After displaying content, the video monitors 201, 203 return to power off, ‘sleep,’ or ‘hibernate.’ This mode would likely save significant power consumption as the video monitors 201, 203 would only power on as necessary.

The apparatus described above with reference to FIGS. 9-12 includes many advantages. First, the perpendicular mounting reduces the shelf space used by the video monitor display, freeing more space to be used for product stocking. The mounting additionally does not interfere with a consumer's ability to select products from the shelf The mounting further presents an optimal viewing angle to consumers as they pass by the video monitor display, creating what is known in the industry as “shopper interruption.”

An additional advantage of the apparatus is that it is readily re-usable. The advertisements or graphics inserted into the retaining ridge are readily changed, and the video monitor display can be quickly and easily remounted at a different shelf location. Once electrically connected at the shelf, the video monitor display can be sent new content associated with a new product. The advertisements or graphics which surround the video monitor display screen are important as they are eye-catching to consumers and can drive sales even during an interruption in power or content to the video monitor display screen itself.

The present disclosure can be implemented by a general purpose computer programmed in accordance with the principals discussed herein. It may be emphasized that the above-described embodiments, particularly any “preferred” embodiments, are merely possible examples of implementations, merely set forth for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure and the present disclosure and protected by the following claims.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine-readable storage device, a machine-readable storage substrate, a memory device, or a combination of one or more of them.

The term “processor” encompasses all apparatus, devices, and machines for processing data, including by way of example a programmable processor, a computer, or multiple processors or computers. The processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, app, script, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network or as an app on a mobile device such as a tablet, PDA or phone.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer or mobile device. Generally, a processor will receive instructions and data from a read only memory or a random access memory or both. The essential elements of a computer are a processor for performing instructions and one or more data memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms data memory including non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube), LCD (liquid crystal display) monitor or other monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims.

What is claimed is:

1. A video monitor display system, comprising:
a display case;
a video monitor disposed within the display case and configured to display content; and
a power distribution system for providing power to the video monitor, comprising:
a tag area controller;
a primary distribution loop connected to the tag area controller; and
an inductively coupled connection providing power from the primary distribution loop to the video monitor.

2. The video monitor display system of claim 1, wherein the video monitor is one of a smart phone, a tablet, a computer, or a television.

3. The video monitor display system of claim 2, wherein the display case is mounted to a retail shelf.

4. The video monitor display system of claim 1, further comprising a motion sensor operationally connected to the video monitor.

5. The video monitor display system of claim 1, wherein the video monitor includes a local memory device for storing content.

6. The video monitor display system of claim 5, further comprising a content database, wherein the video monitor is in wireless communication with the content database.

7. The video monitor display system of claim 1, further comprising an inventory control system comprising:
a sensor, configured to be disposed on the top of a retail shelf and to sense the status of a product;
an electronic shelf label, associated with the sensor and a product and configured to indicate the status of the product;
a processor, wherein the sensor, the electronic shelf label, and the video monitor are each operatively connected to the processor by an inductively coupled connection; and
a computer readable storage medium, the computer readable storage medium comprising instructions stored therein for executing on said processor, the instructions when read and executed, for:
receiving from the sensor at a regular interval a weight measurement of the product;
converting each weight measurement of the product to an inventory as a function of the weight measurement and an individual weight of a product stored in the computer readable storage medium; and
determining an inventory depletion rate based on a plurality of the inventories converted at a regular interval.

8. The video monitor display system of claim 7, wherein the video monitor displays content based on signals received from the inventory control system.

9. The video monitor display system of claim 1, further comprising:
a power source connected to the tag area controller;
a secondary distribution loop connected to the primary distribution loop; and
at least one electronic shelf label connected to the secondary distribution loop.

10. The video monitor display system of claim 1 wherein the display case comprises:
a base, having a proximal end and a distal end, and having an aperture in the proximal end thereof;
a cover, having a proximal end and a distal end, and having an aperture in the distal end thereof;
a side, connected between the base and the cover;
a divider, connected between the base and the cover and dividing the proximal end from the distal end of both the base and the cover;
wherein a compartment is defined by the proximal end of the base, the proximal end of the cover, the divider and at least a portion of the side, and is configured to hold the video monitor and wherein the screen of the video monitor is substantially aligned with the aperture in the proximal end of the base.

11. A display case configured to hold a first video monitor and second video monitor, comprising:
a base, having a proximal end and a distal end, and having an aperture in the proximal end thereof;
a cover, having a proximal end and a distal end, and having an aperture in the distal end thereof;
a side, connected between the base and the cover;
a divider, connected between the base and the cover and dividing the proximal end from the distal end of both the base and the cover;
wherein a first compartment is defined by the proximal end of the base, the proximal end of the cover, the divider and at least a portion of the side, and is configured to hold the first video monitor and wherein the screen of the first video monitor is substantially aligned with the aperture in the proximal end of the base; and
wherein a second compartment is defined by the distal end of the base, the distal end of the cover, the divider and at least a portion of the side, and is configured to hold the second video monitor and wherein the screen of the second video monitor is substantially aligned with the aperture in the distal end of the cover.

12. The display case of claim 11 wherein the side defines an aperture configured to pass through power or data cables connected to the video monitors.

13. The display case of claim 11 wherein the base and cover each have an exterior ridge configured to retain advertising cards.

14. The display case of claim 11 further comprising a mounting bracket configured to mount the display case to a retail shelf.

15. A method of updating locally-stored content at a video monitor, comprising:
providing a computer processor, the computer processor having a computer readable storage medium, the computer readable storage medium comprising instructions stored therein for executing on said processor, the instructions when read and executed, for:
establishing a wireless connection between a content database and a video monitor, the video monitor mounted to a retail shelf and receiving electrical power from an inductively coupled connection to a power distribution system;
searching for updated content;
downloading updated content to a local memory of the video monitor; and
displaying the updated content at the video monitor.

16. The method of claim 15, wherein the searching for updated content is based on the region, retail store, or unique address of the video monitor.

17. The method of claim 16, wherein the content is displayed based on signals received from a motion sensor.

18. The method of claim 16, wherein the content is displayed based on signals received from an inventory control system.

19. The method of claim 15, wherein the searching for updated content is performed at a predetermined interval.
